(19) United States
(12) Patent Application Publication
(10) Pub. No.: US 2018/0186201 A1
(43) Pub. Date: Jul. 5, 2018

(54) Auxiliary Fixture for a Tire Pressure Monitoring Device

(71) Applicant: Orange Electronic Co., Ltd., Taichung City (TW)

(72) Inventors: Hsi-Hsing Hsu, Taichung City (TW); Sheng-Ji Cheng, Taichung City (TW); Po-Yu Chen, Taichung City (TW)

(21) Appl. No.: 15/393,452

(22) Filed: Dec. 29, 2016

(51) Int. Cl. B60C 25/18; B25B 27/00

(52) U.S. Cl. CPC B60C 25/18; B60C 23/0496; B25B 27/0035

(57) ABSTRACT

An auxiliary fixture for a tire pressure monitoring device has a handle, a positioning base, and a holding lever. The positioning base is connected to the handle and has a pivot segment and a clamping segment. The pivot segment is deposited on a rear side of the positioning base and is pivotally connected to the handle. The clamping segment is deposited on a front side of the positioning base, is connected to the pivot segment, and has two adjusting elements and a pushing pin. The adjusting elements are deposited on a front side of the clamping segment, and the pushing pin is deposited between the adjusting elements to press against the tire pressure monitoring device. A distance between the adjusting elements can be adjusted to enable the adjusting elements to clamp the tire pressure monitoring device. The holding lever is connected to the handle.

### BACKGROUND OF THE INVENTION

### 1. Field of Invention

The present invention relates to an auxiliary fixture, and more particularly to an auxiliary fixture for a tire pressure monitoring device that may assemble the tire pressure monitoring device in a tire rim accurately, may be adjustable in use, and may disassemble the tire pressure monitoring device from the tire rim quickly.

### 2. Description of the Related Art

Conventional tire pressure monitoring systems (TPMS) can be classified into a direct-type TPMS and an indirect-type TPMS. The direct-type TPMS has a sensor mounted in a tire to directly detect the air pressure of the tire and to enable the driver to know the actual air pressure of the tire to keep the tire in a stable condition. The indirect-type TPMS has a wheel speed sensor mounted in a braking system of a vehicle to detect the air pressure of the tire by comparing the speed difference of the wheels of the vehicle. With the advances in wireless communication technology, the direct-type TPMS has gradually become the trend of a variety of vehicles to assemble.

With reference to FIG. 14, the conventional direct-type TPMS has a tire pressure monitoring device 50 with a valve stem 51 and a sensor 52 connected to the valve stem 51. The conventional TPMS is assembled in a tire rim 60 by a conventional auxiliary fixture 70, and is connected to an electronic system of a vehicle by wireless communication to provide the air pressure of the tire to the user. In order to assemble the sensor 52 of the conventional direct-type TPMS in the tire rim 60, the conventional auxiliary fixture 70 has a handle 71 and a connecting sleeve 72 pivotally connected to the handle 71. In assembly, a free end of the valve stem 51 of the conventional direct-type TPMS extends through a valve hole 61 of the tire rim 60, and a cap deposited on the free end of the valve stem 51 is released. The connecting sleeve 72 is connected to the free end of the valve stem 51 by screw, and the handle 71 abuts against an outer flange of the tire rim 60 and a downward force is applied on the handle 71. Then, the connecting sleeve 72 is moved upwardly relative to the tire rim 60, and this enables the valve stem 51 that is connected to the connecting sleeve 72 to move up relative to the tire rim 60. Consequently, the valve stem 51 engages in the valve hole 61 of the tire rim 60, and the sensor 52 is deposited in the tire rim 60.

Although the conventional auxiliary fixture 70 may provide an assembling effect to the conventional direct-type TPMS, the conventional direct-type TPMS is securely deposited in the tire rim 60 by pulling the valve stem 51, and this may affect the condition of an axial center of the valve stem 51 aligning with a center of the valve hole 61 when the direction of the downward force or the operator is different. When the axial center of the valve stem 51 is not aligned with the center of the valve hole 61, this means the valve stem 51 is not connected to the valve hole 61 tightly, and the gas in the tire may leak out of the tire via a gap between the valve stem 51 and the valve hole 61. Furthermore, when the valve stem 51 is not correctly deposited in the valve hole 61 and needs to be reassembled, a sheath that is made of rubber material is mounted around an external surface of the valve stem 51, and the sheath may be damaged or broken by a periphery of the tire rim 60 around the valve hole 61 during disassembling of the valve stem 51 from the valve hole 61. Then, the valve stem 51 cannot be used again and this is inconvenient in assembly and may increase the cost of the use. Therefore, the conventional auxiliary fixture 70 still has many problems and inconvenience in use.

With reference to FIG. 15, in view of the aforementioned problems of the conventional auxiliary fixture 70, another conventional auxiliary fixture 80 has been developed and has a handle 81, a positioning base 82, and a holding lever 83. The handle 81 has two abutting wheels 811 deposited at a front end of the handle 81 at a spaced interval. The positioning base 82 is pivotally connected to the front end of the handle 81 and has a positioning recess formed in a front side of the positioning base 82. The holding lever 83 is pivotally connected to the handle 81, selectively abuts the handle, and has an engaging segment 831 deposited on a top end of the holding lever 83.

When the conventional auxiliary fixture 80 is used to assemble the conventional direct-type TPMS, the sensor 52 of the conventional direct-type TPMS is mounted in the positioning recess of the positioning base 82, and the valve stem 51 extends out of the positioning base 82 and is inserted into the valve hole 61. Additionally, the abutting wheels 811 abut against an inner surface of the tire rim 60, and the engaging segment 831 of the holding lever 83 engages an outer flange of the tire rim 60. When a user presses the handle 81 downwardly, the positioning base 82 is pushed to move toward the valve hole 61 by using a connecting position between the handle 81 and the holding lever 83 as fulcrum, and the valve stem 81 is moved with the sensor 52. Then, the valve stem 51 is pushed to deposit in the valve hole 61. The valve stem 51 is connected to the tire rim 60 by the conventional auxiliary fixture 80 pushing the sensor 52, and this may avoid the influence of different directions of the downward force or different operators by pulling the valve stem 51 via the conventional auxiliary fixture 70.

Although the conventional auxiliary fixture 80 may solve the problems of the conventional auxiliary fixture 70, the sensor 52 of the conventional direct-type TPMS may have different sizes or shapes, and the structure of the positioning base 82 of the conventional auxiliary fixture 80 is fixed and cannot be adjusted. Therefore, when the user needs to assemble the sensors 52 of different sizes on the tire rim 60, the positioning base 82 needs to detach from the handle 81, and a new positioning base 82 of a different size corresponding to the sensor 52 is connected to the handle 81. Then, the sensor 52 can be deposited in the new positioning base 82 to assemble the conventional direct-type TPMS on the tire rim 60, and this may increase the assembling time and the cost of purchasing multiple positioning bases 82 of different sizes. Furthermore, another auxiliary fixture for the conventional direct-type TPMS is also disclosed in US 20160303929 A1, and still has the above-mentioned problems. Consequently, the conventional auxiliary fixtures 70, 80 for tire pressure monitoring device need to be improved.

The auxiliary fixture for a tire pressure monitoring device in accordance with the present invention mitigates or obviates the aforementioned problems.

### SUMMARY OF THE INVENTION

The primary objective of the present invention is to provide an auxiliary fixture for a tire pressure monitoring device that may assemble the tire pressure monitoring device in a tire rim accurately, may be adjustable in use, and may disassemble the tire pressure monitoring device from the tire rim quickly.

The auxiliary fixture for a tire pressure monitoring device in accordance with the present invention has a handle, a positioning base, and a holding lever. The positioning base is connected to the handle and has a pivot segment and a clamping segment. The pivot segment is deposited on a rear side of the positioning base and is pivotally connected to the handle. The clamping segment is deposited on a front side of the positioning base, is connected to the pivot segment, and has two adjusting elements and a pushing pin. The adjusting elements are deposited on a front side of the clamping segment, and the pushing pin is deposited between the adjusting elements to press against the tire pressure monitoring device. A distance between the adjusting elements can be adjusted to enable the adjusting elements to clamp the tire pressure monitoring device. The holding lever is connected to the handle.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of an auxiliary fixture for a tire pressure monitoring device in accordance with the present invention;

FIG. 2 is an exploded perspective view of the auxiliary fixture for a tire pressure monitoring device in FIG. 1;

FIG. 3 is a further exploded perspective view of the auxiliary fixture for a tire pressure monitoring device in FIG. 2;

FIG. 4 is an operational and enlarged top view of the auxiliary fixture for a tire pressure monitoring device in FIG. 1, connected to a tire pressure monitoring device;

FIG. 5 is an operational side view in partial section of the auxiliary fixture for a tire pressure monitoring device in FIG. 1, assembled the tire pressure monitoring device in a tire rim;

FIG. 6 is a perspective view of a second embodiment of an auxiliary fixture for a tire pressure monitoring device in accordance with the present invention;

FIG. 7 is an enlarged perspective view of the auxiliary fixture for a tire pressure monitoring device in FIG. 6, shown with some components hidden;

FIG. 8 is an exploded and enlarged perspective view of the auxiliary fixture for a tire pressure monitoring device in FIG. 6;

FIG. 9 is an enlarged front side view of the auxiliary fixture for a tire pressure monitoring device in FIG. 6, shown with some components hidden and connected to a tire pressure monitoring device;

FIG. 10 is an enlarged perspective view of a third embodiment of an auxiliary fixture for a tire pressure monitoring device in accordance with the present invention;

FIG. 11 is an exploded perspective view of the auxiliary fixture for a tire pressure monitoring device in FIG. 10;

FIG. 12 is an enlarged side view in partial section of the auxiliary fixture for a tire pressure monitoring device in FIG. 10;

FIG. 13 is an enlarged perspective view of a fourth embodiment of an auxiliary fixture for a tire pressure monitoring device in accordance with the present invention;

FIG. 14 is an operational side view in partial section of a conventional fixture tool for a tire pressure monitoring device in accordance with the prior art; and

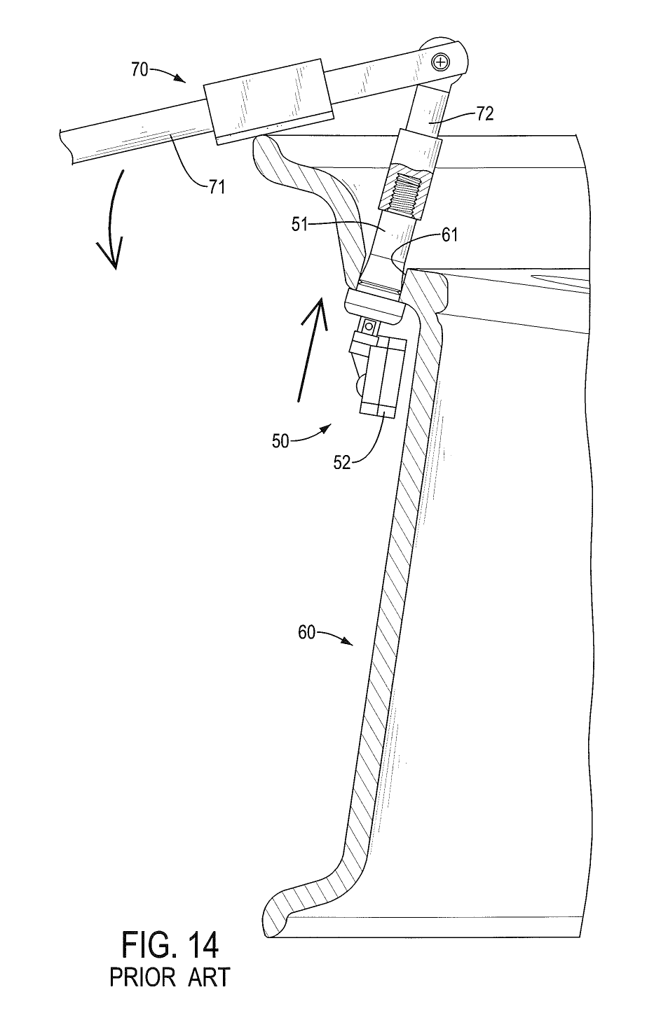

FIG. 15 is an operational side view in partial section of another conventional fixture tool for a tire pressure monitoring device in accordance with the prior art.

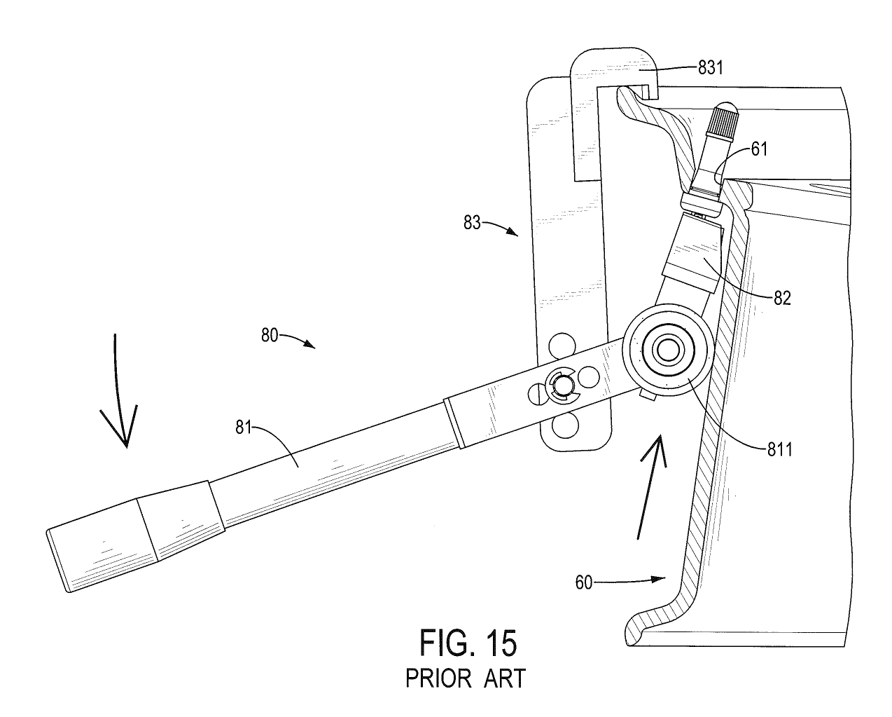

### DETAILED DESCRIPTION OF THE INVENTION

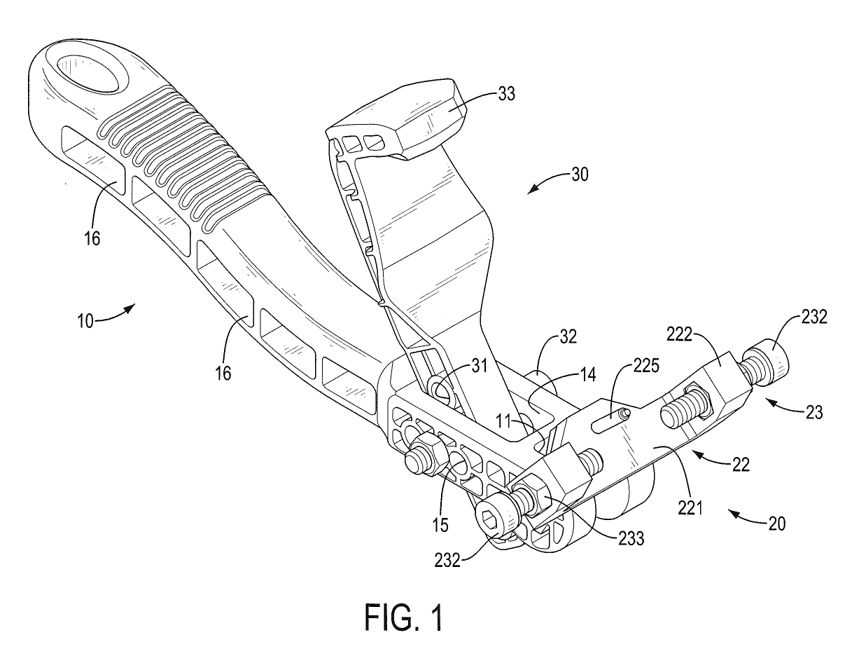

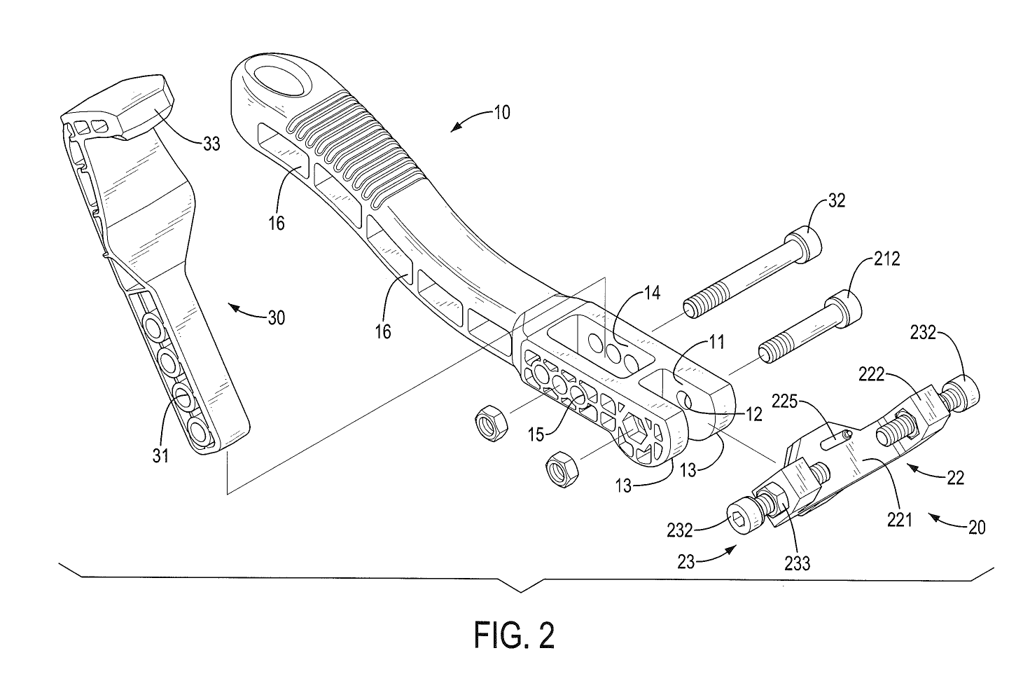

With reference to FIGS. 1 to 3, a first embodiment of an auxiliary fixture for a tire pressure monitoring device in accordance with the present invention has a handle 10, a positioning base 20, and a holding lever 30.

The handle 10 has a front end, a top side, a bottom side, a front side, two sidewalls, a connecting recess 11, two connecting holes 12, two abutting segments 13, a pivot recess 14, multiple pivot holes 15, and at least one notch 16. The connecting recess 11 is formed through the top side, the front side, and the bottom side of the handle 10 at the front end of the handle 10. One of the connecting holes 12 is formed through one of the sidewalls of the handle 10 at the front end of the handle 10 and communicates with the connecting recess 11, and the other one of the connecting holes 12 is formed through the other one of the sidewalls of the handle 10 at the front end of the handle 10 and communicates with the connecting recess 11. The connecting holes 12 align with each other.

The abutting segments 13 may be curved, and are deposited on the bottom side of the handle 10 at the front end of the handle 10 respectively on the sidewalls of the handle 10 beside the connecting recess 11. The pivot recess 14 is formed through the top side and the bottom side of the handle 10 adjacent to the connecting recess 11 at a spaced interval. The pivot holes 15 are formed through the sidewalls of the handle 10 and communicate with the pivot recess 14, and each one of the pivot holes 15 at one of the sidewalls of the handle 10 aligns with one of the pivot holes 15 at the other one of the sidewalls of the handle 10. Each one of the at least one notch 16 is formed in each one of the sidewalls of the handle 10 away from the connecting recess 11 and the pivot recess 14 to reduce the total weight of the handle 10.

The positioning base 20 is pivotally connected to the handle 10 and has a rear side, a front side, a pivot segment 21 and a clamping segment 22. The pivot segment 21 is deposited on the rear side of the positioning base 20, is pivotally connected to the handle 10 in the connecting recess 11, and has a through hole 211, a first pivotal element 212, and an abutting pin 213. The through hole 211 is transversally formed through the pivot segment 21 and aligns with the connecting holes 12 of the handle 10. The first pivotal element 212 is mounted through the through hole 211 of the pivot segment 21, and is connected to the connecting holes 12 of the handle 10 to connect the pivot segment 21 of the positioning base 20 with the handle 10. The abutting pin 213 is deposited on the pivot segment 21 and selectively abuts against the bottom side of the handle 10 to limit an angle between the positioning base 20 and the handle 10.

The clamping segment 22 may be U-shaped, is deposited on the front side of the positioning base 20, and is connected to the pivot segment 21. Additionally, the clamping segment 22 may be formed with the pivot segment 21 as a single piece. The clamping segment 22 has a front side, two positioning arms 222, a positioning recess 221, two adjusting elements 23, two limiting recesses 223, two communicating holes 224, and a pushing pin 225. The positioning arms 222 are deposited on the front side of the clamping segment 22 at a spaced interval. The positioning recess 221 is deposited in the front side of the clamping segment 22 between the positioning arms 222. One of the adjusting elements 23 is deposited on one of the positioning arms 222, and the other one of the adjusting elements 23 is deposited on the other one of the positioning arms 222, and each one of the adjusting elements 23 may move relative to the corresponding positioning arm 222 to change a distance between the adjusting elements 23.

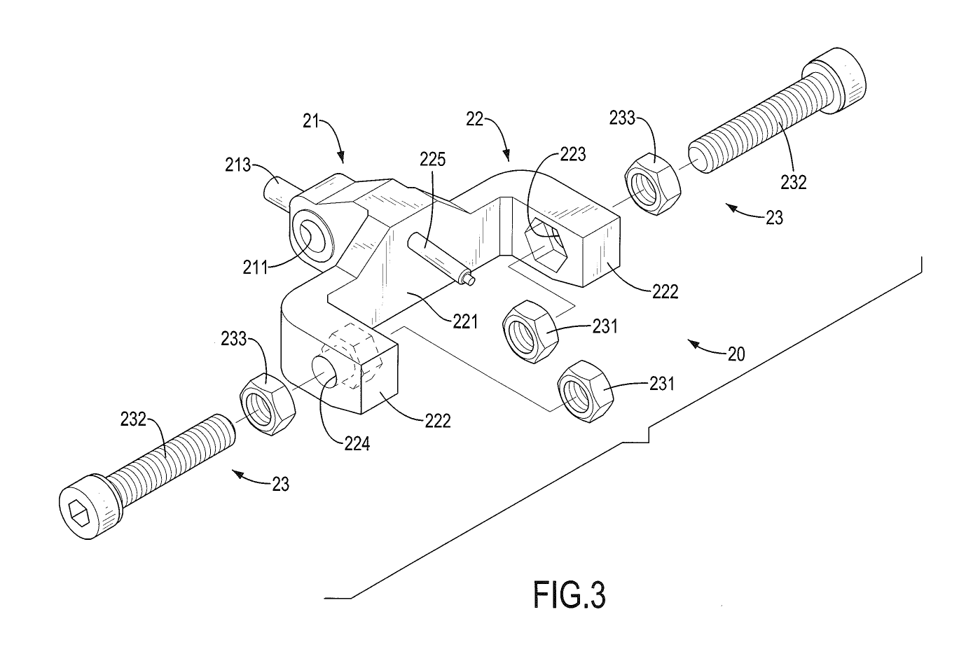

With further reference to FIG. 3, each one of the limiting recesses 223 may be polygonal and is formed in an inner side of one of the positioning arms 222 to enable the limiting recesses 223 to face each other. Each one of the communicating holes 224 is formed in an outer side of one of the positioning arms 222 and communicates with the limiting recess 223 that is deposited on the same positioning arm 222. The pushing pin 225 is deposited in the positioning recess 221 between the positioning arms 222.

Each one of the adjusting elements 23 has a limiting ring 231, an adjusting rod 232, and a connecting ring 233. The limiting ring 231 is mounted in one of the limiting recesses 223 and has a shape corresponding to a shape of the corresponding limiting recess 223 to hold the limiting ring 231 securely in the corresponding limiting recess 223. The adjusting rod 232 has a clamping end and a rotating end. The clamping end of the adjusting rod 232 extends through the corresponding limiting recess 223 via the corresponding communicating hole 224, is connected to the limiting ring 231, and extends into the positioning recess 221 of the clamping segment 22. The rotating end of the adjusting rod 232 extends out of the outer side of the corresponding positioning arm 222. The connecting ring 233 is deposited on the adjusting rod 232 and abuts the outer side of the corresponding positioning arm 222. The adjusting rod 232 is deposited on the corresponding positioning arm 222 of the clamping segment 22 by the limiting ring 231 and the connecting ring 233, and the position of each one of the adjusting rods 232 may be adjusted independently relative to a corresponding positioning arm 222. Then, the distance between the adjusting elements 23 can be changed and adjusted.

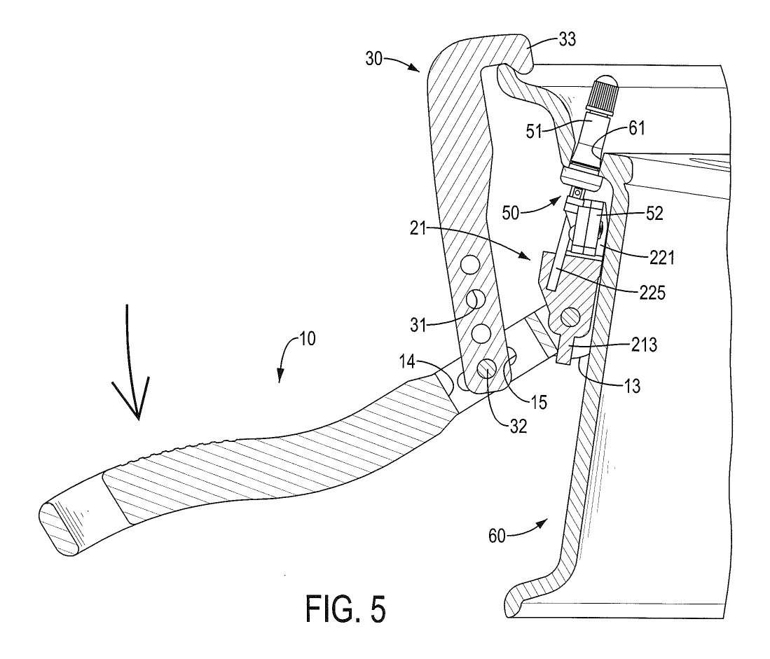

The holding lever 30 is pivotally connected to the handle 10 and has a lower end, a top end, two opposite sidewalls, multiple adjusting holes 31, a second pivotal element 32, and an engaging segment 33. The lower end of the holding lever 30 extends through the pivot recess 14 from the top side to the bottom side of the handle 10. The adjusting holes 31 are transversally formed through the opposite sidewalls at spaced intervals adjacent to the lower end of the holding lever 30 to enable one of the adjusting holes 31 to align with two of the pivot holes 15 that align with each other at the sidewalls of the handle 10. The second pivotal element 32 is mounted through one of the adjusting holes 31, and is connected to two of the pivot holes 15 that align with the corresponding adjusting hole 31 to connect the holding lever 30 pivotally with the handle 10 at the rear side of the positioning base 20. The engaging segment 33 is deposited on the top end of the holding lever 30 to engage an outer flange of a tire rim 60 as shown in FIG. 5.

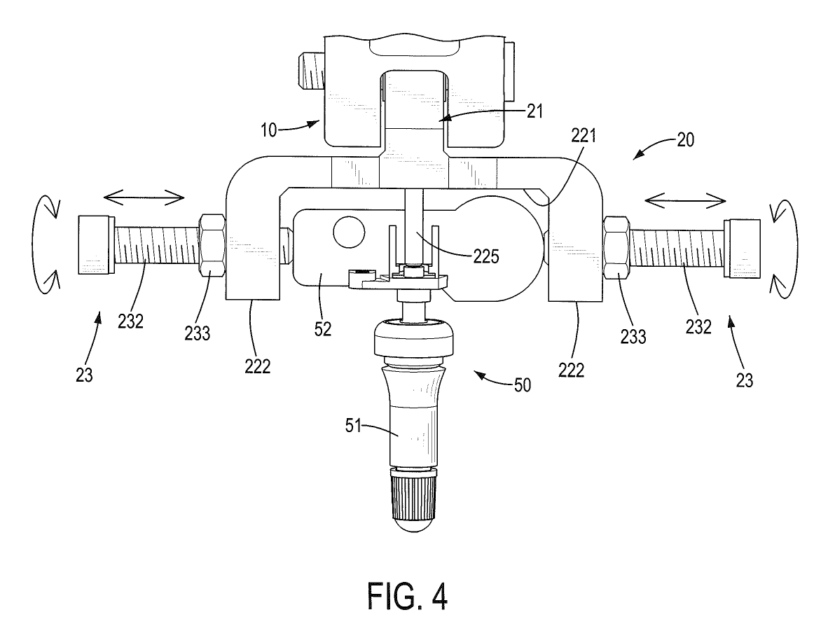

With reference to FIG. 4, when the first embodiment of an auxiliary fixture for a tire pressure monitoring device in accordance with the present invention in use, the sensor 52 of the tire pressure monitoring device 50 of the conventional direct-type TPMS is mounted in the positioning recess 221 of the positioning base 20, and is pressed against the pushing pin 225. The adjusting rods 232 may be rotated respectively to change the positions of the adjusting rods 232 relative to the positioning arms 222 according to the size of the sensor 52. Furthermore, one of the adjusting rods 232 can be rotated to adjust separately or two of the adjusting rods 232 are rotated to adjust relative to the positioning arms 222, and this may provide a bidirectional independent adjusting effect to the positioning base 20, and the sensor 52 can be securely held in the positioning recess 221 by the adjusting rods 232 and the pushing pin 225.

With reference to FIG. 5, the valve stem 51 is inserted into the valve hole 61 of the tire rim 60 after the sensor 52 is securely held in the positioning recess 221, the abutting segments 13 of the handle 10 abut against the inner surface of the tire rim 60, and the engaging segment 33 of the holding lever 30 engages the outer flange of the tire rim 60. Then, the handle 10 is pressed to move downwardly to enable the valve stem 51 to stably deposit in the valve hole 61 of the tire rim 60 via the positioning base 20, and this may improve the assembling effect of the conventional direct-type TPMS. In addition, sensors 52 of different sizes can be securely mounted in the positioning recesses 221 by adjusting the distance between the adjusting elements 23 relative to the positioning recess 221 of the positioning base 20, and this may reduce the cost of purchasing positioning bases 20 of different sizes.

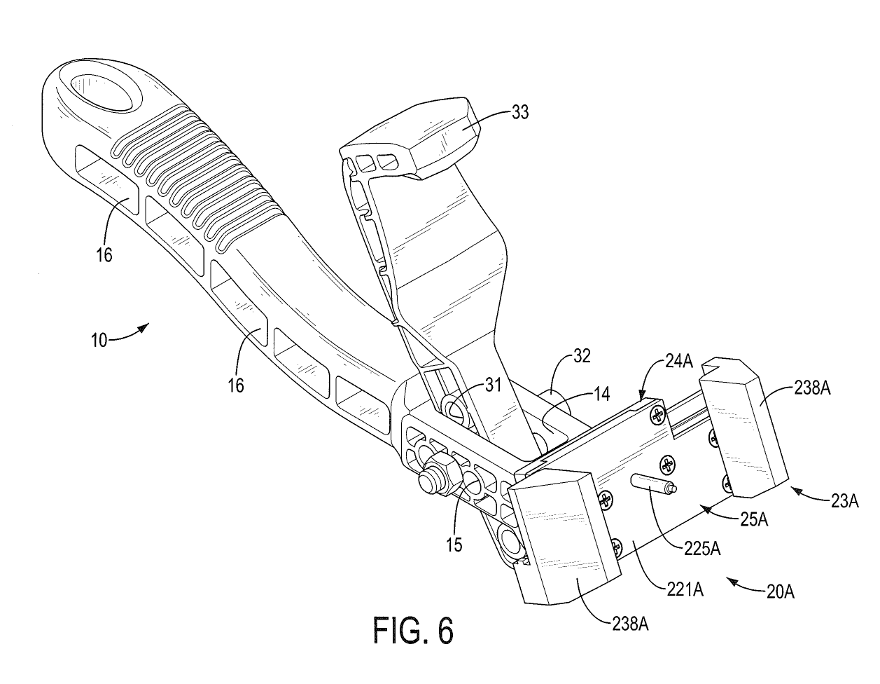

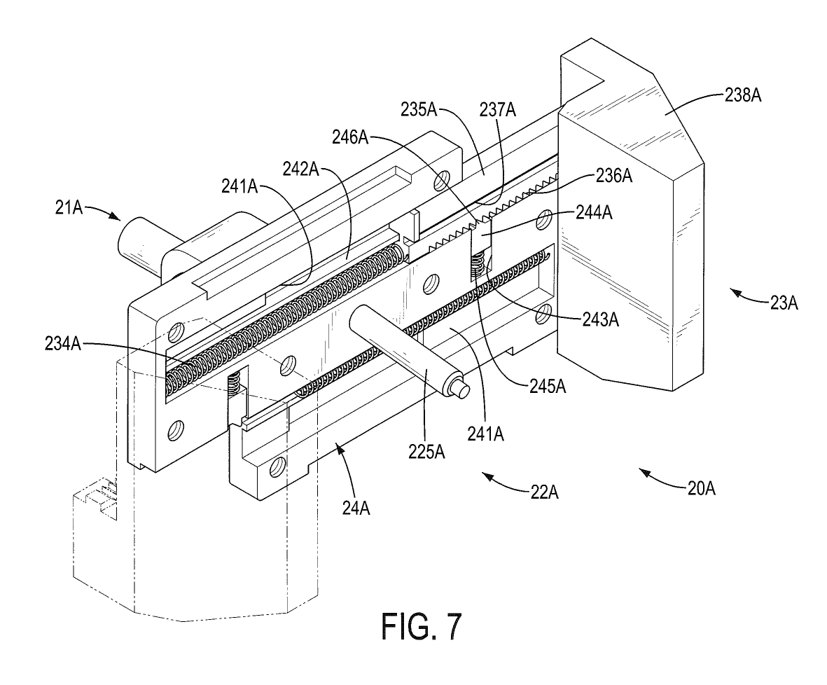

With reference to FIGS. 6 to 8, a second embodiment of an auxiliary fixture for a tire pressure monitoring device in accordance with the present invention is substantially the same as the first embodiment as shown in FIG. 1 except for the following features. The clamping segment 22A has a bottom seat 24A and a covering panel 25A. The bottom seat 24A is formed with the pivot segment 21A and has a front side, a rear side, two side edges, two guiding slots 241A, two mounting ribs 242A, two communicating recesses 243A, two limiting blocks 244A, two first elastic elements 245A, two release holes 247A, and two pulling tabs 248A. The guiding slots 241A are transversally formed in the front side of the bottom seat 24A and are parallel with each other at a spaced interval. Each one of the guiding slots 241A has an open end, a closed end, and a bottom face. The open end of each one of the guiding slots 241A is formed through one of the side edges of the bottom seat 24A, and the open ends of the guiding slots 241A are deposited on different side edges of the bottom seat 24A.

Each one of the mounting ribs 242A is formed on and protrudes from the bottom face of one of the guiding slots 241A from the closed end to the open end of the corresponding guiding slot 241A. The communicating recesses 243A are longitudinal formed in the front side of the bottom seat 24A, and each one of the communicating recesses 243A communicates with the one of the guiding slots 241A that is at the open end of the corresponding guiding slot 241A.

The limiting blocks 244A are respectively and moveably mounted in the communicating recesses 243A, and each one of the limiting blocks 244A has an outer side, an inner side, and a limiting tooth 246A. The outer side of each one of the limiting blocks 244A selectively extends into the guiding slot 241A that communicates with the corresponding communicating recess 243A. The limiting tooth 246A is formed on and protrudes from the outer side of the limiting block 244A to enable the limiting tooth 246A to selectively extend in the corresponding guiding slot 241A. The first elastic elements 245A are respectively mounted in the communicating recesses 243A, and respectively abut the inner sides of the limiting blocks 244A to push the limiting blocks 244A toward the corresponding guiding slots 241A and to enable the limiting teeth 246A to respectively extend in the corresponding guiding slots 241A.

Additionally, the release holes 247A are elongated, are formed through the rear side of the bottom seat 24A, and respectively communicate with the communicating recesses 243A. The pulling tabs 248A are respectively formed on and protrude from the limiting blocks 244A, and extend out of the rear side of bottom seat 24A respectively via the release holes 247A. Then, the user may pull one of the pulling tabs 248A to move the corresponding limiting block 244A relative to the corresponding communicating recess 243A to compress the corresponding first elastic element 245A and to enable the limiting tooth 246A to move in the corresponding communicating recess 243A.

The covering panel 25A is connected to the front side of the bottom seat 24A to close the guiding slots 241A, and has an inner side and two connecting ribs 251A. The inner side of the covering panel 25A faces the front side of the bottom seat 24A. The connecting ribs 251A are transversally formed on and protrude from the inner side of the covering panel 25A, and respectively align with the mounting ribs 242A of the bottom seat 24A.

Furthermore, the adjusting elements 23A may move relative to the clamping segment 22A, and each one of the adjusting elements 23A has a second elastic element 234A, a guiding arm 235A, and a clamping block 238A. The second elastic elements 234A of the adjusting elements 23A are respectively mounted in the guiding slots 241A of the bottom seat 24A. The guiding arm 235A of the adjusting element 23A is inserted in one of the guiding slots 241A, abuts against the second elastic element 234A that is mounted in the corresponding guiding slot 241A, and has a forming side, an inner side, an outer side, an engaging rack 236A, and two mounting slots 237A. The forming side of the guiding arm 235A faces the communicating recess 243A that communicates with the corresponding guiding slot 241A. The engaging rack 236A is formed on and protrudes from the forming side of the guiding arm 235A, and selectively engages the limiting tooth 246A of the limiting block 244A that is mounted in the corresponding communicating recess 243A.

The mounting slots 237A are respectively formed in the inner side and the outer side of the guiding arm 235A, and one of the mounting slots 237A is disposed around one of the mounting ribs 242A of the bottom seat 24A, and the other one of the mounting slots 237A is disposed around the connecting rib 251A of the covering panel 25A that aligns with the corresponding mounting rib 242A. Then, each one of the guiding arms 235A may move stably relative to the bottom seat 24A and the covering panel 25A by the engagement between the mounting slots 237A, the corresponding mounting rib 242A, and the corresponding connecting rib 251A. The clamping block 238A is connected to an end of the guiding arm 235A that is opposite to the second elastic element 234A, and can be used as one of the positioning arms 222 of the positioning base 20 in the first embodiment of the auxiliary fixture for a tire pressure monitoring device in accordance with the present invention. Additionally, the positioning recess 221A is deposited in the front side of the clamping segment 22A between the clamping blocks 238A.

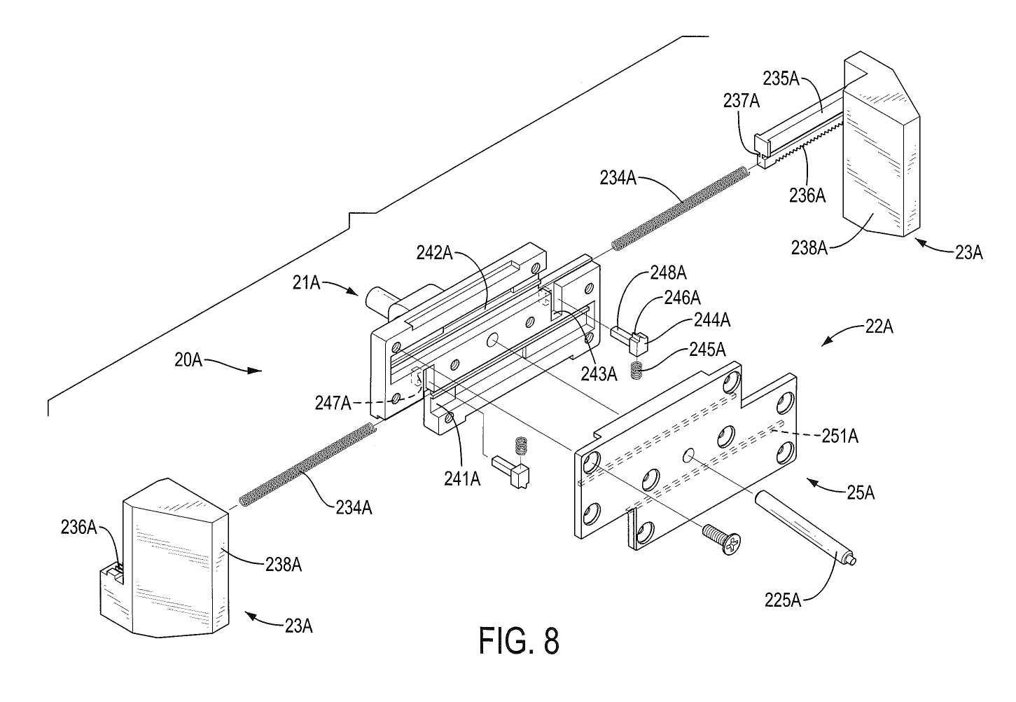

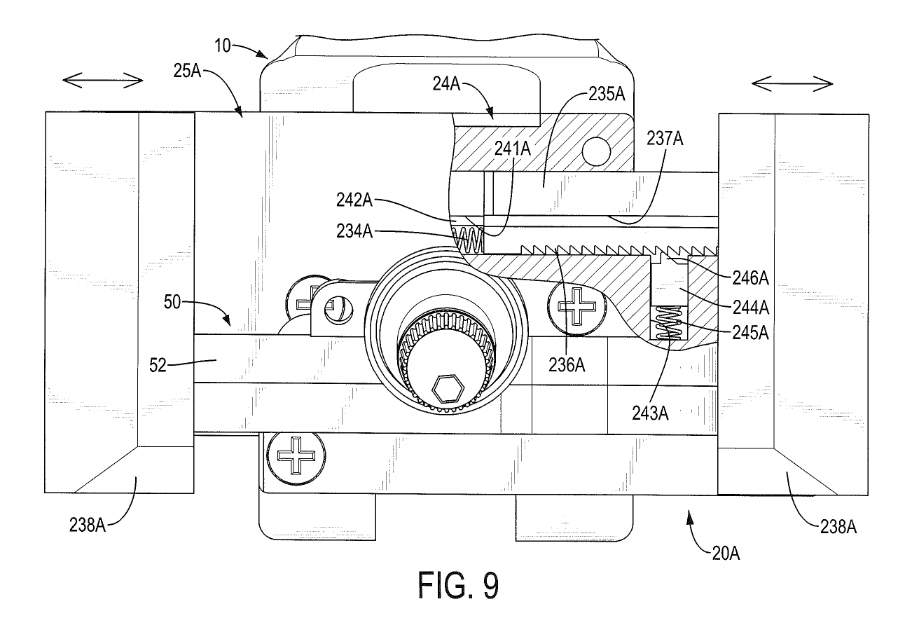

With reference to FIGS. 8 and 9, when the second embodiment of an auxiliary fixture for a tire pressure monitoring device in accordance with the present invention in use, the sensor 52 of the conventional direct-type TPMS is mounted in the positioning recess 221A between the covering panel 25A and the clamping blocks 238A, and is pressed against the pushing pin 225A. One of the clamping blocks 238A is pushed toward the positioning recess 221A according to the size of the sensor 52, and this enables the guiding arm 235A that is connected to the corresponding clamping block 238A to move inwardly relative to the bottom seat 24A along the corresponding guiding slot 241A.

During the movement of the guiding arm 235A, the limiting tooth 246A of the corresponding limiting block 244A that engages the engaging rack 236A of the guiding arm 235A may make the limiting block 244A moving by the movement force of the guiding arm 235A to compress the corresponding first elastic element 245A, and this enables the limiting tooth 246 to disengage from the engaging rack 236A. When the guiding arm 235A is moved to enable the corresponding clamping block 238A to abut against the sensor 52, the compressed first elastic element 245A may push the limiting block 244A to move relative to the corresponding communicating recess 243A, and this enables the limiting tooth 246A to engage the engaging rack 236A again, and the corresponding clamping block 238A may securely abut against the sensor 52. Then, the sensor 52 of the conventional direct-type TPMS can be securely held in the positioning recess 221A by the clamping blocks 238A and the pushing pin 225A.

Furthermore, when the size of the sensor 52 of the conventional direct-type TPMS is larger than the distance between the clamping blocks 238A, with reference to FIG. 8, one of the pulling tabs 248A is pulled to move relative to the corresponding release hole 247A, and this enables the limiting block 244A that is connected to the corresponding pulling tab 248A to move and to compress the corresponding first elastic element 245A. Then, the limiting tooth 246A of the limiting block 244A disengages from the engaging rack 236A of the corresponding guiding arm 235A, and the corresponding guiding arm 235 may move outwardly relative to the bottom seat 24A to increase the distance between the clamping blocks 238A. After adjusting the distance between the clamping blocks 238A, the sensor 52 with larger size can be mounted in the positioning recess 221A and held securely between the clamping blocks 238A.

Further, the structure and operation of the two guiding arms 235A are independent, and the user may push one or two of the clamping blocks 238A according to the user's need or the size of the sensor 52 to hold the sensor 52 securely between the clamping blocks 238A. The operation of depositing the conventional direct-type TPMS on the tire rim 60 of the second embodiment of the auxiliary fixture for a tire pressure monitoring device in accordance with the present invention is same as the first embodiment of the auxiliary fixture for a tire pressure monitoring device in accordance with the present invention, and is not described in detail.

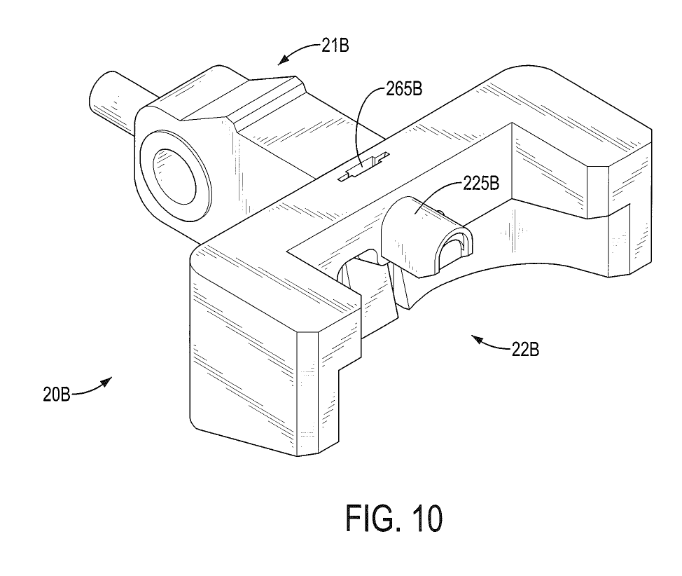

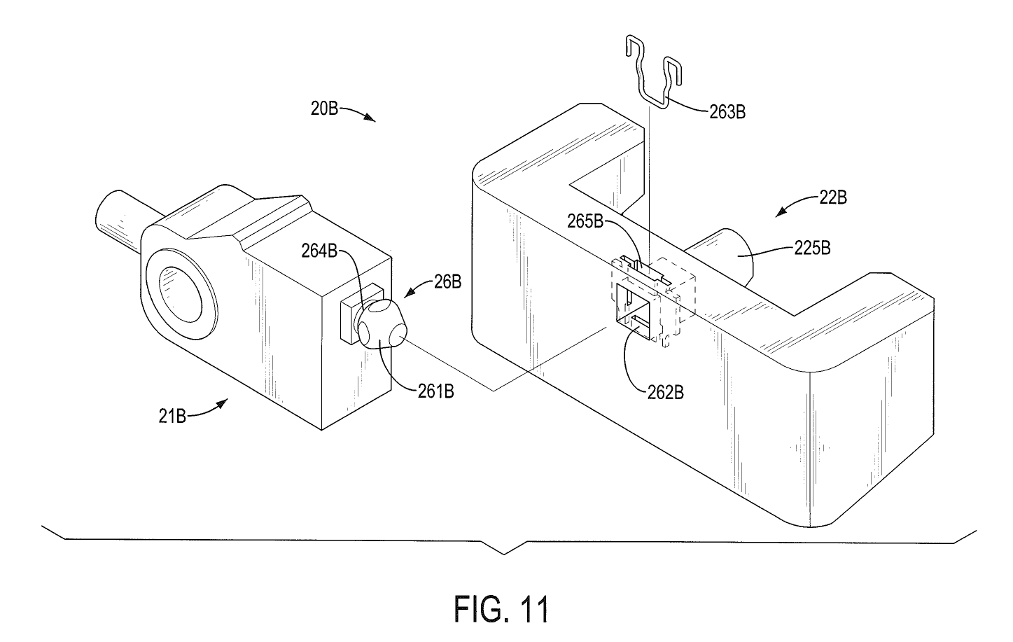

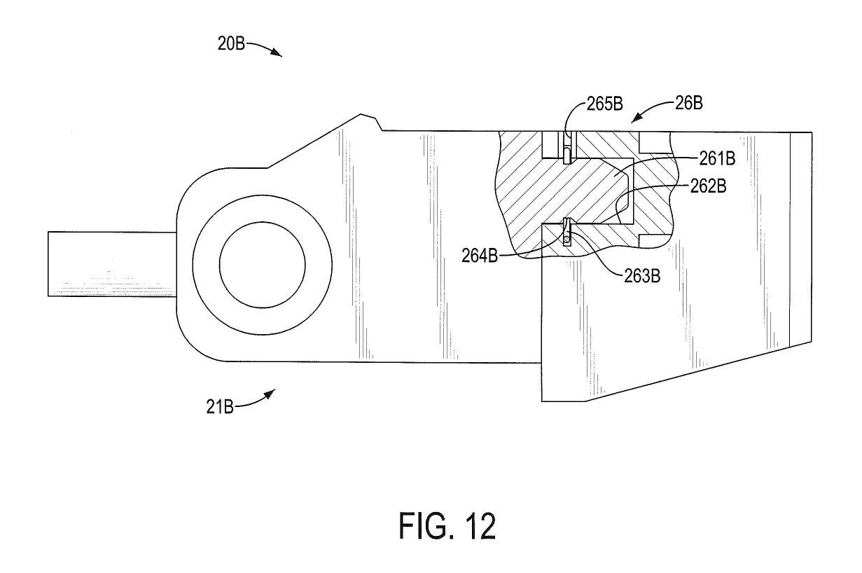

With reference to FIGS. 10 to 12, a third embodiment of an auxiliary fixture for a tire pressure monitoring device in accordance with the present invention is substantially the same as the first embodiment as shown in FIG. 1 except for the following features. The pivot segment 21B and the clamping segment 22B of the positioning base 20B are two separating components, and the positioning base 20B has a quick release structure 26B mounted between the pivot segment 21B and the clamping segment 22B. The quick release structure 26B has a mounting head 261B, a mounting recess 262B, an installing mouth 265B, and an elastic buckle 263B. The mounting head 261B may be conical, and is formed on and protrudes from a front side of the pivot segment 21B, and has a neck portion 264B. The mounting recess 262B is formed in a rear side of the clamping segment 22B and is selectively disposed around the mounting head 261B to connect the clamping segment 22B with the pivot segment 21B. The installing mouth 265B is formed in a top side of the clamping segment 22B and communicates with the mounting recess 262B. The elastic buckle 263B may be U-shaped, is deposited in the mounting recess 262B via the installing mouth 265B and engages the neck portion 264B of the mounting head 261B, and this enables the clamping segment 22B to connect with the pivot segment 21B via the quick release structure 26B.

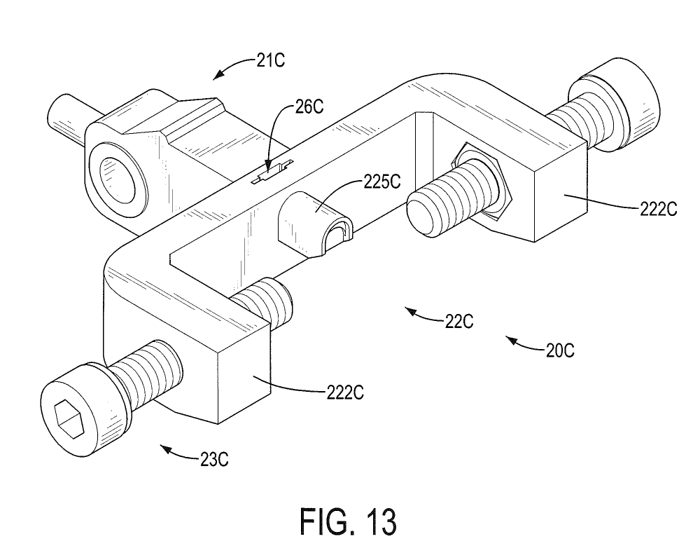

With reference to FIG. 13, a fourth embodiment of an auxiliary fixture for a tire pressure monitoring device in accordance with the present invention is substantially the same as the first embodiment and the third embodiment as respectively shown in FIGS. 1 and 10 except for the following features. The clamping segment 22C is connected to the pivot segment 21C via the quick release structure 26C, and the clamping segment 22C has an adjusting element 23C deposited on each one of the positioning arms 222C.

According to the above-mentioned, when the auxiliary fixture for a tire pressure monitoring device in accordance with the present invention is in use, the sensor 52 of the conventional direct-type TPMS is pushed by the structural configuration between the handle 10, the positioning base 20, 20A, 20B, 20C, and the holding lever 30, and the valve stem 51 can be deposited in the valve hole 61 of the tire rim 60. Then, the influence and problem of different directions of the downward force or different operators by pulling the valve stem 51 via the conventional auxiliary fixture 70 can be improved and avoided.

Furthermore, the two adjusting elements 23, 23A, 23C deposited on the positioning base 20, 20A, 20C can be adjusted to change the distance between the two adjusting elements 23, 23A, 23C, and the quick release structure 26B is deposited between the pivot segment 21B and the clamping segment 22B. Then, when using the sensors 52 of different sizes, the user may adjust the distance between the adjusting elements 23, 23A, 23C of the positioning base 20, 20A, 20C or replace the clamping segment 22B, 22C of the positioning base 20B, 20C quickly by the quick release structure 26B, 26C to clamp the sensors 52 of different sizes, and this may reduce the cost and time of assemblement and may assemble the tire pressure monitoring device 50 in a tire rim 60 accurately, may be adjustable in use, and may disassemble the tire pressure monitoring device 50 from the tire rim 60 quickly.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An auxiliary fixture for a tire pressure monitoring device comprising:
a handle;
a positioning base connected to the handle and having
a rear side;
a front side;
a pivot segment deposited on the rear side of the positioning base and connected to the handle; and
a clamping segment deposited on the front side of the positioning base, connected to the pivot segment, and having
a front side;
two adjusting elements deposited on the front side of the clamping segment; and
a pushing pin deposited on the clamping segment between the two adjusting elements to press against the tire pressure monitoring device; and
a holding lever connected to the handle;
wherein a distance between the two adjusting elements is adjustable to enable the two adjusting elements to clamp the tire pressure monitoring device.

2. The auxiliary fixture as claimed in claim 1, wherein the clamping segment has a positioning recess deposited between the two adjusting elements to receive the tire pressure monitoring device and to enable the tire pressure monitoring device to press against the pushing pin.

3. The auxiliary fixture as claimed in claim 2, wherein the clamping segment has two positioning arms deposited on the front side of the clamping segment, the positioning recess is deposited between the positioning arms, and the two adjusting elements are respectively deposited on the positioning arms.

4. The auxiliary fixture as claimed in claim 3, wherein
the handle has
a front end;
a top side;
a bottom side;
a front side;
a connecting recess formed through the top side, the front side, and the bottom side of the handle at the front end of the handle; and
a pivot recess formed through the top side and the bottom side of the handle adjacent to the connecting recess at a spaced interval;
the pivot segment of the positioning base is pivotally connected to the handle in the connecting recess; and
the holding lever is pivotally connected to the handle and has a bottom end extending through the pivot recess form the top side to the bottom side of the handle.

5. The auxiliary fixture as claimed in claim 2, wherein the camping segment of the positioning base is formed with the pivot segment as a single piece.

6. The auxiliary fixture as claimed in claim 3, wherein
the clamping segment has
two limiting recesses, and each one of the limiting recesses formed in an inner side of one of the positioning arms to enable the limiting recesses to face each other; and
two communicating holes, and each one of the communicating holes formed in an outer side of one of the positioning arms and communicating with the limiting recess that is deposited on the same positioning arm; and
each one of the two adjusting elements has
a limiting ring securely mounted in one of the limiting recesses;
an adjusting rod having
a clamping end extending through the corresponding limiting recess via the corresponding communicating hole, connected to the limiting ring, and extending into the positioning recess of the clamping segment; and
a rotating end extending out of the outer side of the corresponding positioning arm; and
a connecting ring deposited on the adjusting rod and abutting the outer side of the corresponding positioning arm.

7. The auxiliary fixture as claimed in claim 4, wherein
the clamping segment has
two limiting recesses, and each one of the limiting recesses formed in an inner side of one of the positioning aims to enable the limiting recesses to face each other; and
two communicating holes, and each one of the communicating holes formed in an outer side of one of the positioning arms and communicating with the limiting recess that is deposited on the same positioning arm; and
each one of the two adjusting elements has
a limiting ring securely mounted in one of the limiting recesses;
an adjusting rod having
a clamping end extending through the corresponding limiting recess via the corresponding communicating hole, connected to the limiting ring, and extending into the positioning recess of the clamping segment; and
a rotating end extending out of the outer side of the corresponding positioning arm; and
a connecting ring deposited on the adjusting rod and abutting the outer side of the corresponding positioning arm.

8. The auxiliary fixture as claimed in claim 5, wherein
the clamping segment has
two limiting recesses, and each one of the limiting recesses formed in an inner side of one of the positioning arms to enable the limiting recesses to face each other; and
two communicating holes, and each one of the communicating holes formed in an outer side of one of the positioning arms and communicating with the limiting recess that is deposited on the same positioning arm; and
each one of the two adjusting elements has
a limiting ring securely mounted in one of the limiting recesses;
an adjusting rod having
a clamping end extending through the corresponding limiting recess via the corresponding communicating hole, connected to the limiting ring, and extending into the positioning recess of the clamping segment; and
a rotating end extending out of the outer side of the corresponding positioning arm; and
a connecting ring deposited on the adjusting rod and abutting the outer side of the corresponding positioning arm.

9. The auxiliary fixture as claimed in claim 3, wherein
the clamping segment has
a bottom seat formed with the pivot segment and having
a front side;
a rear side;
two side edges;
two guiding slots transversally formed in the front side of the bottom seat, parallel with each other at a spaced interval, and each one of the guiding slots having
an open end formed through one of the side edges of the bottom seat, and the open ends of the guiding slots deposited on different side edges of the bottom seat;
a closed end; and
a bottom face;
two communicating recesses longitudinal formed in the front side of the bottom seat, and each one of the communicating recesses communicating with the one of the guiding slots at the open end of the corresponding guiding slot;
two limiting blocks respectively and moveably mounted in the communicating recesses, and each one of the limiting blocks having
an outer side selectively extending into the guiding slot that communicates with the corresponding communicating recess;
an inner side; and
a limiting tooth formed on and protruding from the outer side of the limiting block, and selectively extending in the corresponding guiding slot; and
two first elastic elements respectively mounted in the communicating recesses, and respectively abutting the inner sides of the limiting blocks to push the limiting blocks toward the corresponding guiding slots and to enable the limiting teeth to respectively extend in the corresponding guiding slots; and
a covering panel connected to the front side of the bottom seat to close the guiding slots; and
each one of the two adjusting elements has
a second elastic element mounted in one of the guiding slots of the bottom seat;
a guiding arm inserted in the corresponding guiding slot, abutting against the second elastic element that is mounted in the corresponding guiding slot, and having
a forming side facing the communicating recess that communicates with the corresponding guiding slot; and
an engaging rack formed on and protruding from the forming side of the guiding arm, and selectively engaging the limiting tooth of the limiting block that is mounted in the corresponding communicating recess; and
a clamping block connected to an end of the guiding arm that is opposite to the second elastic element, and being used as one of the positioning arms of the positioning base.

10. The auxiliary fixture as claimed in claim 4, wherein
the clamping segment has
a bottom seat formed with the pivot segment and having
a front side;
a rear side;
two side edges;
two guiding slots transversally formed in the front side of the bottom seat, parallel with each other at a spaced interval, and each one of the guiding slots having
an open end formed through one of the side edges of the bottom seat, and the open ends of the guiding slots deposited on different side edges of the bottom seat;
a closed end; and
a bottom face;
two communicating recesses longitudinal formed in the front side of the bottom seat, and each one of the communicating recesses communicating with the one of the guiding slots at the open end of the corresponding guiding slot;
two limiting blocks respectively and moveably mounted in the communicating recesses, and each one of the limiting blocks having
an outer side selectively extending into the guiding slot that communicates with the corresponding communicating recess;
an inner side; and
a limiting tooth formed on and protruding from the outer side of the limiting block, and selectively extending in the corresponding guiding slot; and
two first elastic elements respectively mounted in the communicating recesses, and respectively abutting the inner sides of the limiting blocks to push the limiting blocks toward the corresponding guiding slots and to enable the limiting teeth to respectively extend in the corresponding guiding slots; and
a covering panel connected to the front side of the bottom seat to close the guiding slots; and
each one of the two adjusting elements has
a second elastic element mounted in one of the guiding slots of the bottom seat;
a guiding arm inserted in the corresponding guiding slot, abutting against the second elastic element that is mounted in the corresponding guiding slot, and having
a forming side facing the communicating recess that communicates with the corresponding guiding slot; and
an engaging rack formed on and protruding from the forming side of the guiding arm, and selectively engaging the limiting tooth of the limiting block that is mounted in the corresponding communicating recess; and
a clamping block connected to an end of the guiding arm that is opposite to the second elastic element, and being used as one of the positioning arms of the positioning base.

11. The auxiliary fixture as claimed in claim 5, wherein
the clamping segment has
a bottom seat formed with the pivot segment and having
a front side;
a rear side;
two side edges;
two guiding slots transversally formed in the front side of the bottom seat, parallel with each other at a spaced interval, and each one of the guiding slots having
an open end formed through one of the side edges of the bottom seat, and the open ends of the guiding slots deposited on different side edges of the bottom seat;
a closed end; and
a bottom face;
two communicating recesses longitudinal formed in the front side of the bottom seat, and each one of the communicating recesses communicating with the one of the guiding slots at the open end of the corresponding guiding slot;
two limiting blocks respectively and moveably mounted in the communicating recesses, and each one of the limiting blocks having
an outer side selectively extending into the guiding slot that communicates with the corresponding communicating recess;
an inner side; and
a limiting tooth formed on and protruding from the outer side of the limiting block, and selectively extend in the corresponding guiding slot; and
two first elastic elements respectively mounted in the communicating recesses, and respectively abutting the inner sides of the limiting blocks to push the limiting blocks toward the corresponding guiding slots and to enable the limiting teeth to respectively extending in the corresponding guiding slots; and
a covering panel connected to the front side of the bottom seat to close the guiding slots; and
each one of the two adjusting elements has
a second elastic element mounted in one of the guiding slots of the bottom seat;
a guiding arm inserted in the corresponding guiding slot, abutting against the second elastic element that is mounted in the corresponding guiding slot, and having
a forming side facing the communicating recess that communicates with the corresponding guiding slot; and
an engaging rack formed on and protruding from the forming side of the guiding arm, and selectively engaging the limiting tooth of the limiting block that is mounted in the corresponding communicating recess; and
a clamping block connected to an end of the guiding arm that is opposite to the second elastic element, and being used as one of the positioning arms of the positioning base.

12. The auxiliary fixture as claimed in claim 9, wherein the bottom seat has
two release holes being elongated, formed through the rear side of the bottom seat, and respectively communicating with the communicating recesses; and
two pulling tabs respectively formed on and protruding from the limiting blocks, and extending out of the rear side of bottom seat respectively via the release holes.

13. The auxiliary fixture as claimed in claim 10, wherein the bottom seat has
two release holes being elongated, formed through the rear side of the bottom seat, and respectively communicating with the communicating recesses; and
two pulling tabs respectively formed on and protruding from the limiting blocks, and extending out of the rear side of bottom seat respectively via the release holes.

14. The auxiliary fixture as claimed in claim 11, wherein the bottom seat has
two release holes being elongated, formed through the rear side of the bottom seat, and respectively communicating with the communicating recesses; and
two pulling tabs respectively formed on and protruding from the limiting blocks, and extending out of the rear side of bottom seat respectively via the release holes.

15. The auxiliary fixture as claimed in claim 12, wherein
the bottom seat has two mounting ribs, and each one of the mounting ribs is formed on and protruding from the bottom face of one of the guiding slots from the closed end to the open end of the corresponding guiding slot;
the covering panel has
an inner side facing the front side of the bottom seat; and
two connecting ribs transversally formed on and protruding from the inner side of the covering panel, and respectively aligning with the mounting ribs of the bottom seat; and
each one of the guiding arms has
an inner side;
an outer side; and
two mounting slots respectively formed in the inner side and the outer side of the guiding arm, and one of the mounting slots disposed around one of the mounting ribs of the bottom seat, and the other one of the mounting slots disposed around the connecting rib of the covering panel that aligns with the corresponding mounting rib.

16. The auxiliary fixture as claimed in claim 13, wherein
the bottom seat has two mounting ribs, and each one of the mounting ribs is formed on and protruding from the bottom face of one of the guiding slots from the closed end to the open end of the corresponding guiding slot;
the covering panel has
an inner side facing the front side of the bottom seat; and
two connecting ribs transversally formed on and protruding from the inner side of the covering panel, and respectively aligning with the mounting ribs of the bottom seat; and
each one of the guiding arms has
an inner side;
an outer side; and
two mounting slots respectively formed in the inner side and the outer side of the guiding arm, and one of the mounting slots disposed around one of the mounting ribs of the bottom seat, and the other one of the mounting slots disposed around the connecting rib of the covering panel that aligns with the corresponding mounting rib.

17. The auxiliary fixture as claimed in claim 14, wherein
the bottom seat has two mounting ribs, and each one of the mounting ribs is formed on and protruding from the bottom face of one of the guiding slots from the closed end to the open end of the corresponding guiding slot;
the covering panel has
an inner side facing the front side of the bottom seat; and
two connecting ribs transversally formed on and protruding from the inner side of the covering panel, and respectively aligning with the mounting ribs of the bottom seat; and
each one of the guiding arms has
an inner side;
an outer side; and
two mounting slots respectively formed in the inner side and the outer side of the guiding arm, and one of the mounting slots disposed around one of the mounting ribs of the bottom seat, and the other one of the mounting slots disposed around the connecting rib of the covering panel that aligns with the corresponding mounting rib.

18. The auxiliary fixture as claimed in claim 9, wherein
the bottom seat has two mounting ribs, and each one of the mounting ribs is formed on and protruding from the bottom face of one of the guiding slots from the closed end to the open end of the corresponding guiding slot;
the covering panel has
an inner side facing the front side of the bottom seat; and
two connecting ribs transversally formed on and protruding from the inner side of the covering panel, and respectively aligning with the mounting ribs of the bottom seat; and
each one of the guiding arms has
an inner side;
an outer side; and
two mounting slots respectively formed in the inner side and the outer side of the guiding arm, and one of the mounting slots disposed around one of the mounting ribs of the bottom seat, and the other one of the mounting slots disposed around the connecting rib of the covering panel that aligns with the corresponding mounting rib.

19. The auxiliary fixture as claimed in claim 10, wherein
the bottom seat has two mounting ribs, and each one of the mounting ribs is formed on and protruding from the bottom face of one of the guiding slots from the closed end to the open end of the corresponding guiding slot;
the covering panel has
an inner side facing the front side of the bottom seat; and
two connecting ribs transversally formed on and protruding from the inner side of the covering panel, and respectively aligning with the mounting ribs of the bottom seat; and
each one of the guiding arms has
an inner side;
an outer side; and
two mounting slots respectively formed in the inner side and the outer side of the guiding arm, and one of the mounting slots disposed around one of the mounting ribs of the bottom seat, and the other one of the mounting slots disposed around the connecting rib of the covering panel that aligns with the corresponding mounting rib.

20. The auxiliary fixture as claimed in claim 11, wherein
the bottom seat has two mounting ribs, and each one of the mounting ribs is formed on and protruding from the bottom face of one of the guiding slots from the closed end to the open end of the corresponding guiding slot;
the covering panel has
an inner side facing the front side of the bottom seat; and
two connecting ribs transversally formed on and protruding from the inner side of the covering panel, and respectively aligning with the mounting ribs of the bottom seat; and
each one of the guiding arms has
an inner side;
an outer side; and
two mounting slots respectively formed in the inner side and the outer side of the guiding arm, and one of the mounting slots disposed around one of the mounting ribs of the bottom seat, and the other one of the mounting slots disposed around the connecting rib of the covering panel that aligns with the corresponding mounting rib.

21. An auxiliary fixture for a tire pressure monitoring device comprising:
a handle;
a positioning base connected to the handle and having
a rear side;
a front side;
a pivot segment deposited on the rear side of the positioning base and connected to the handle;
a clamping segment deposited on the front side of the positioning base, and having a pushing pin deposited on the clamping segment to press against the tire pressure monitoring device; and
a quick release structure mounted between the pivot segment and the clamping segment to connect the clamping segment with the pivot segment; and
a holding lever connected to the handle.

22. The auxiliary fixture as claimed in claim 21, wherein the quick release structure has
a mounting head formed on and protruding from a front side of the pivot segment, and having a neck portion;
a mounting recess formed in a rear side of the clamping segment and selectively disposed around the mounting head to connect the clamping segment with the pivot segment;
an installing mouth formed in a top side of the clamping segment and communicating with the mounting recess; and
an elastic buckle deposited in the mounting recess via the installing mouth and engaging the neck portion of the mounting head.

23. The auxiliary fixture as claimed in claim 22, wherein
the handle has
a front end;
a top side;
a bottom side;
a front side;
a connecting recess formed through the top side, the front side, and the bottom side of the handle at the front end of the handle; and
a pivot recess formed through the top side and the bottom side of the handle adjacent to the connecting recess at a spaced interval;
the pivot segment of the positioning base is pivotally connected to the handle in the connecting recess; and
the holding lever is pivotally connected to the handle and has a bottom end extending through the pivot recess form the top side to the bottom side of the handle.

24. The auxiliary fixture as claimed in claim 21, wherein
the clamping segment has
a front side; and
two adjusting elements deposited on the front side of the clamping segment; and
the pushing pin is deposited on the clamping segment between the two adjusting elements;
wherein a distance between the two adjusting elements is adjustable to enable the two adjusting elements to clamp the tire pressure monitoring device.

25. The auxiliary fixture as claimed in claim 22, wherein
the clamping segment has
a front side; and
two adjusting elements deposited on the front side of the clamping segment; and
the pushing pin is deposited on the clamping segment between the two adjusting elements;
wherein a distance between the two adjusting elements is adjustable to enable the two adjusting elements to clamp the tire pressure monitoring device.

26. The auxiliary fixture as claimed in claim 23, wherein
the clamping segment has
a front side; and
two adjusting elements deposited on the front side of the clamping segment; and
the pushing pin is deposited on the clamping segment between the two adjusting elements;
wherein a distance between the two adjusting elements is adjustable to enable the two adjusting elements to clamp the tire pressure monitoring device.

27. The auxiliary fixture as claimed in claim 24, wherein
the clamping segment has
a positioning recess deposited between the two adjusting elements to receive the tire pressure monitoring device and to enable the tire pressure monitoring device to press against the pushing pin; and
two positioning arms deposited on the front side of the clamping segment; and
the two adjusting elements are respectively deposited on the positioning aims to deposit the positioning recess between the positioning arms.

28. The auxiliary fixture as claimed in claim 25, wherein
the clamping segment has
a positioning recess deposited between the two adjusting elements to receive the tire pressure monitoring device and to enable the tire pressure monitoring device to press against the pushing pin; and
two positioning arms deposited on the front side of the clamping segment; and
the two adjusting elements are respectively deposited on the positioning arms to deposit the positioning recess between the positioning arms.

29. The auxiliary fixture as claimed in claim 26, wherein
the clamping segment has
a positioning recess deposited between the two adjusting elements to receive the tire pressure monitoring device and to enable the tire pressure monitoring device to press against the pushing pin; and
two positioning arms deposited on the front side of the clamping segment; and
the two adjusting elements are respectively deposited on the positioning arms to deposit the positioning recess between the positioning arms.

30. The auxiliary fixture as claimed in claim 27, wherein
the clamping segment has
two limiting recesses, and each one of the limiting recesses formed in an inner side of one of the positioning arms to enable the limiting recesses to face each other; and
two communicating holes, and each one of the communicating holes formed in an outer side of one of the positioning arms and communicating with the limiting recess that is deposited on the same positioning arm; and
each one of the two adjusting elements has
a limiting ring securely mounted in one of the limiting recesses;
an adjusting rod having
a clamping end extending through the corresponding limiting recess via the corresponding communicating hole, connected to the limiting ring, and extending into the positioning recess of the clamping segment; and
a rotating end extending out of the outer side of the corresponding positioning arm; and
a connecting ring deposited on the adjusting rod and abutting the outer side of the corresponding positioning arm.

31. The auxiliary fixture as claimed in claim 28, wherein
the clamping segment has
two limiting recesses, and each one of the limiting recesses formed in an inner side of one of the positioning arms to enable the limiting recesses to face each other; and
two communicating holes, and each one of the communicating holes formed in an outer side of one of the positioning arms and communicating with the limiting recess that is deposited on the same positioning arm; and
each one of the two adjusting elements has
a limiting ring securely mounted in one of the limiting recesses;
an adjusting rod having
a clamping end extending through the corresponding limiting recess via the corresponding communicating hole, connected to the limiting ring, and extending into the positioning recess of the clamping segment; and
a rotating end extending out of the outer side of the corresponding positioning arm; and
a connecting ring deposited on the adjusting rod and abutting the outer side of the corresponding positioning arm.

32. The auxiliary fixture as claimed in claim 29, wherein
the clamping segment has
two limiting recesses, and each one of the limiting recesses formed in an inner side of one of the positioning arms to enable the limiting recesses to face each other; and
two communicating holes, and each one of the communicating holes formed in an outer side of one of the positioning arms and communicating with the limiting recess that is deposited on the same positioning arm; and
each one of the two adjusting elements has
a limiting ring securely mounted in one of the limiting recesses;
an adjusting rod having
a clamping end extending through the corresponding limiting recess via the corresponding communicating hole, connected to the limiting ring, and extending into the positioning recess of the clamping segment; and
a rotating end extending out of the outer side of the corresponding positioning arm; and
a connecting ring deposited on the adjusting rod and abutting the outer side of the corresponding positioning arm.
